(19) United States
(12) Patent Application Publication
(10) Pub. No.: US 2010/0192023 A1
(43) Pub. Date: Jul. 29, 2010

(54) Optimizing Exception and Error Propagation Through Scopes

(75) Inventor: Michael Hilton Dawson, Ottawa (CA)

Correspondence Address: IBM CORPORATION;INTELLECTUAL PROPERTY LAW, 11501 BURNET ROAD, AUSTIN, TX, 78758, US

(73) Assignee: INTERNATIONAL BUSINESS MACHINES CORPORATION, Armonk, NY (US)

(21) Appl. No.: 12/359,528

(22) Filed: Jan. 26, 2009

(51) Int. Cl. G06F 11/07; G06F 9/455

(52) U.S. Cl. 714/48; 718/1; 714/E11.023; 714/E11.025; 714/E11.024

(57) ABSTRACT

A method of optimizing the handling of throwables in a real-time compliant java virtual machine includes receiving a throwable generated within a first memory scope area when that scope is exited, traversing the Java stack to identify the application code where the received throwable will be, or should be, caught/handled during program execution, identifying a second memory scope area within the stack of memory scopes, the second memory scope area being the area which will be active during catching and handling of the received throwable, and propagating information from the received throwable to a new ThrowBoundaryError in the second memory scope area irrespective of the scopes between them.

### BACKGROUND

Embodiments of the present invention are generally directed to real-time compliant Java Virtual Machine (JVM) applications, and more particularly, to methods of optimizing the propagation of errors and exceptions (throwables) between scopes in the same.

Generally in the Real-Time Specification for Java, version 1.0.1, which is hereby incorporated by reference herein in its entirety, memory management for real-time compliant JVM includes scoped memory. A new throwable (ThrowBoundaryError) is introduced to allow the propagation of throwables as scopes are exited. A ThrowBoundaryError is used to propagate information from a throwable into an outer scope so that it is accessible after the scope in which the original throwable was created has been exited.

Within applications running on a JVM, if a throwable is pending during an exit from a scope, information from the throwable must be cloned into an outer memory area (i.e., of an outer scope) and added to a new ThrowBoundaryError object. It follows that as Java threads include deeper and deeper scopes, the cloning must be repeated relative to scope depth.

### BRIEF SUMMARY

An embodiment of the invention includes a method of optimizing the handling of throwables in a real-time compliant java virtual machine. The method includes receiving a throwable generated within a first memory scope area on exit from that scope in a real-time java compliant virtual machine, traversing a Java stack to identify application code where the received throwable will be, or should be, caught/handled during program execution, identifying a second memory scope area within the Java stack, the second memory scope area being the area which will be active during catching and handling of the received throwable, and propagating information from the received throwable to the second memory scope area irrespective of the scope areas between the first and second scope area.

Another embodiment of the invention includes a computer program product. The computer program product includes a computer program with computer executable instructions that, when executed on a computer apparatus, direct a processor of the computer apparatus to execute the computer executable instructions, the computer executable instructions including a method of optimizing the handling of throwables in a real-time compliant java virtual machine. The method includes receiving a throwable generated within a first memory scope area on exit from that scope in a real-time java compliant virtual machine, traversing a Java stack to identify application code where the received throwable will be, or should be, caught/handled during program execution, identifying a second memory scope area within the Java stack, the second memory scope area being the area which will be active during catching and handling of the received throwable, and propagating information from the received throwable to the second memory scope area irrespective of the scope areas between the first and second scope area.

Another embodiment of the invention includes a system. The system includes a computer processor, a real-time compliant java virtual machine implemented on the computer processor, memory in communication with the computer processor, and a scoped memory space implemented within the memory. The system is configured to perform a method including receiving a throwable generated within a first memory scope area on exit from that scope in a real-time java compliant virtual machine, traversing a Java stack to identify application code where the received throwable will be, or should be, caught/handled during program execution, identifying a second memory scope area within the Java stack, the second memory scope area being the area which will be active during catching and handling of the received throwable, and propagating information from the received throwable to the second memory scope area irrespective of the scope areas between the first and second scope area.

### BRIEF DESCRIPTION OF THE SEVERAL VIEWS OF THE DRAWINGS

These and other features, aspects, and advantages of the present invention will become better understood as the following detailed description is read with reference to the accompanying drawings in which like reference numerals represent like elements throughout the drawings, wherein:

FIG. 1 illustrates an example memory layout that includes scopes, according to an example embodiment;

FIG. 2 illustrates an example memory layout that includes scopes, according to an example embodiment;

FIG. 3 illustrates an example memory layout that includes scopes, according to an example embodiment;

FIG. 4 illustrates an example memory layout that includes scopes, according to an example embodiment;

FIG. 5 illustrates a method of optimizing the handling of throwables in a real-time java compliant virtual machine, according to an example embodiment; and

FIG. 6 illustrates a computer apparatus, according to an example embodiment;

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof Therefore, the terminology used herein is for the purpose of describing particular embodiments only and is not intended to be limiting of example embodiments.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

It is further noted that the terminology used herein is considered consistent with implementations of example embodiments, and is appropriate for description of example embodiments. Furthermore, different terms may be used singularly or in multiple forms to describe components or steps which may be substantially similar. For example, the terms “throwable,” “exception,” and “error” may be used interchangeably if referencing substantially similar objects. Furthermore, the terminology “real-time,” “real-time java,” “RTSJ,” and/or other abbreviations or terms representing JVM compliancy, methods, applications, or other suitable representations of real-time java objects may be used interchangeably herein.

Hereinafter, example embodiments of the present invention will be described in detail. According to example embodiments, a solution is provided involving the optimization of throwable propagation within a virtual machine. The methodologies described herein provide the best mode of optimization of throwable propagation through the propagation of throwable information to an appropriate memory area. This propagation occurs within the applicable virtual machine itself, and therefore reduces the amount of preemptive writing/coding for applications and limits the necessary knowledge of throwable handling compared to conventional methodologies. More clearly, as the propagation/handling of throwables is implemented within the virtual machine, application developers are not required to develop new code or alter prior application code to predefined patterns for handling throwables for all applicable instances in order to retain throwable information. As such, the propagation facilitates more general approaches to application development and does not place restrictions on scoped memory space for the purpose of throwable information retention.

Therefore, a technical effect of example embodiments is that the impact of small, intermediate scopes to information retention is reduced through the optimized propagation of throwable information. Also, memory space of intermediate scopes may be reduced accordingly.

Hereinafter example embodiments are described more fully with reference to the figures.

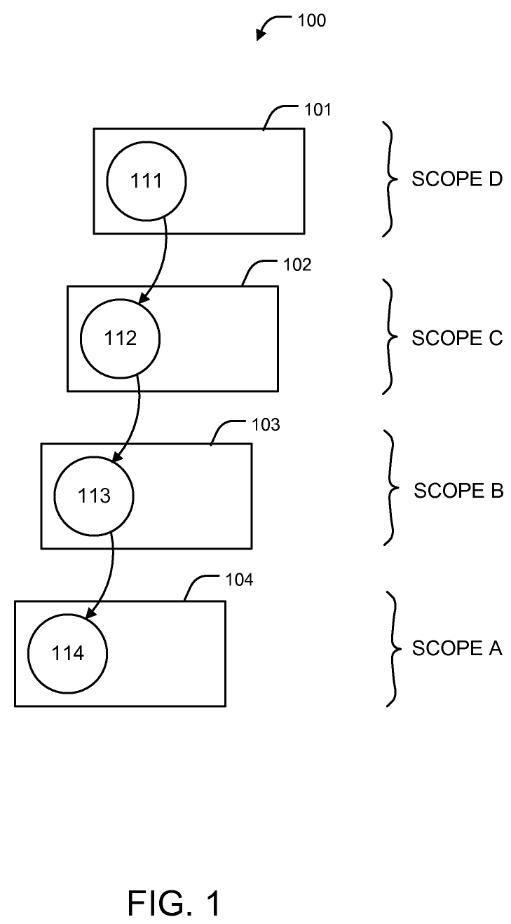

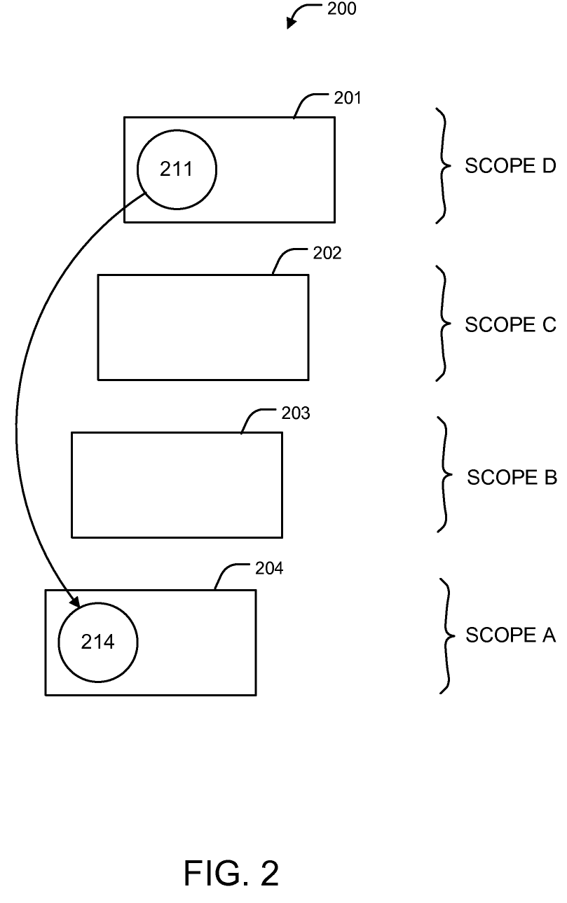

FIG. 1 illustrates an example memory layout. As illustrated, the memory layout 100 includes a plurality of scopes A, B, C, and D (104, 103, 102, 101). For example, if a throwable 111 is generated in scope D (101), conventional methodologies require the cloning of information from throwable 111 through each intermediate scope upon exit of a particular scope. Thus, upon exit of scope D (101), information from 111 is cloned into throwable 112 of scope C (102). Upon exit of scope C (102), the information from the new throwable 112 is cloned into throwable 113 of scope B (103). Upon exit of scope B (103), information from the new throwable 113 is cloned into throwable 114 of scope A (104). As illustrated, each throwable 111, 112, 113, 114, is generated upon exit of an associated scope. Turning to FIG. 2, an example scoped memory depicting an optimized handling methodology is illustrated.

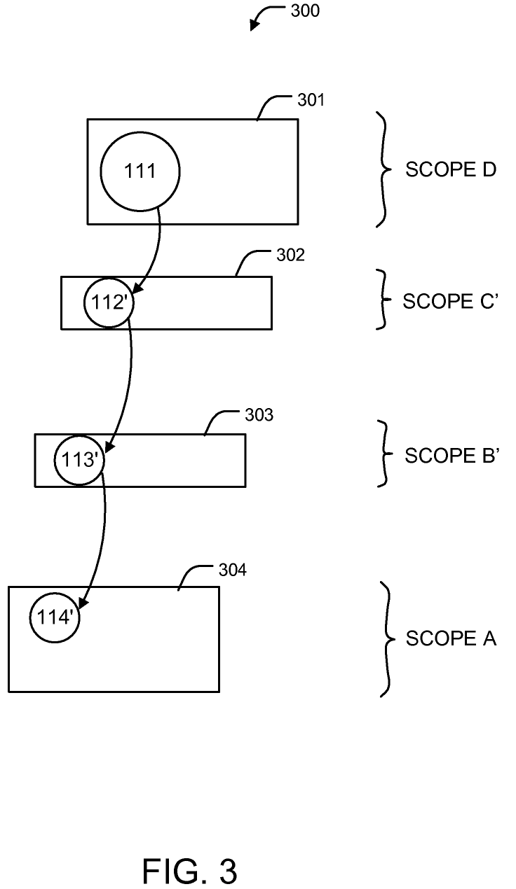

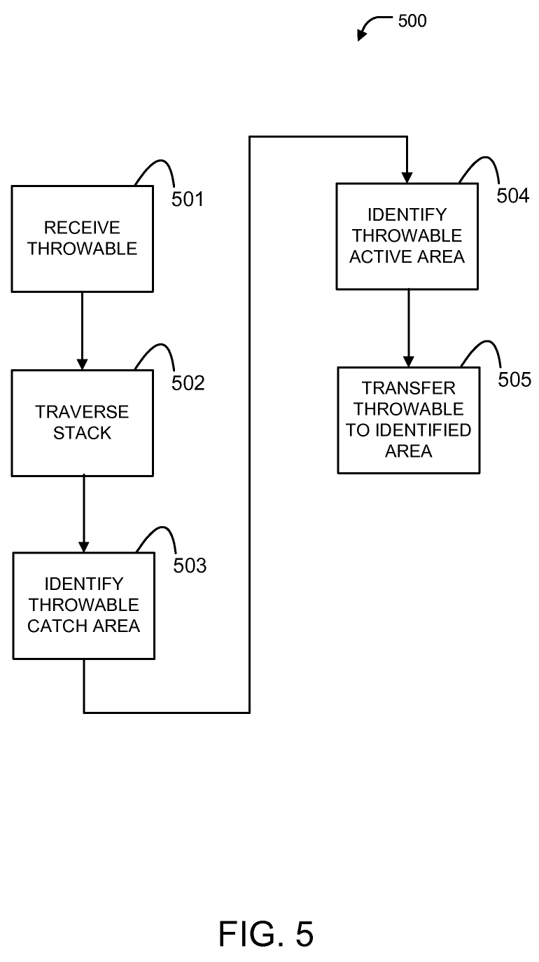

According to FIG. 2, the memory layout 200 includes a plurality of scopes A, B, C, and D (204, 203, 202, 201). For example, if a throwable 211 is generated, the methodologies described herein facilitate its propagation to an outer memory space such that cloning information from it is not necessary during all scope exits. Particular portions of the methodology description are reserved for discussion of FIG. 5. Turning back to FIG. 2, as throwable 211 is generated in scope D (201), information from it may be propagated to scope a new throwable 214 in A (204). Thus, throwable information cloning routines for scopes C and B (203-202) during scope exit are reduced. This is in contrast to the additional cloning steps of FIG. 1. It follows that an additional benefit is apparent as the memory space requirements for scopes C and B (202 and 203) are reduced as no throwables are to be stored therein within this particular example. Turning to FIG. 3, an alternative example depicting conventional propagation of throwables through limited memory space scopes is illustrated.

According to FIG. 3, the memory layout 300 includes a plurality of scopes A, B′, C′, and D (304, 303, 302, 301). As illustrated, the scopes B′ and C′ (303, 302) are of relatively smaller size than scopes A and D (304, 301). For example, if a throwable 111 is generated at scope D (301), conventional methodologies require the cloning of information from throwable 111 through each intermediate scope upon exit of a particular scope. However, as intermediate scopes of this example are limited in size, there may be issues as the information which can be retained may be limited to a subset of original information thereby affecting information retention through propagation through the scopes.

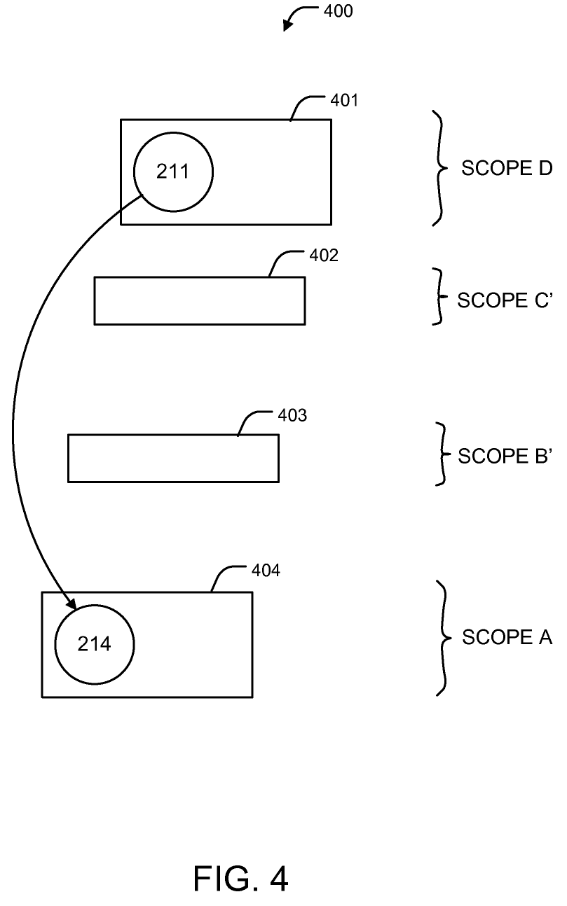

For example, upon exit of scope D (301), information from throwable 111 is cloned into throwable 112′ of scope C′ (302). New throwable 112′ includes only a subset of the information of original throwable 111. Upon exit of scope C (302), the information from throwable 112′ is cloned into new throwable 113′ of scope B′ (303). Again, throwable 113′ includes only a subset of the information of original throwable 111, as information from throwable 113′ is cloned from throwable 112′ during scope exit. Upon exit of scope B (303), information from the new throwable 113′ is cloned into new throwable 114′ of scope A (304). As illustrated, each throwable 111, 112′, 113 ′, 114′, is generated upon exit of an associated scope. It is apparent that the information in throwable 114′ is limited in size and contains only a subset of the information of the originally generated throwable 111. Turning to FIG. 4, an example scoped memory scope depicting an optimized handling methodology is illustrated which reduces these effects.

According to FIG. 4, the memory layout 400 includes a plurality of scopes A, B′, C′, and D (404, 403, 402, 401). For example, if a throwable 211 is generated, the methodologies described herein facilitate its propagation to an outer memory space such that cloning is not necessary during all scope exits. Particular portions of the methodology description are reserved for discussion of FIG. 5. Turning back to FIG. 4, as throwable 211 is generated at scope D (401), information from it may be propagated to scope A (404) as a new throwable 214. Thus, throwable information cloning routines for scopes C′ and B′ (403-402) during scope exit are reduced. This is in contrast to the additional cloning steps of FIGS. 1 and 3, and therefore preserves the information contained in throwable 211 during propagation. Therefore, as the memory space for scopes C′ and B′ (402 and 403) is limited in this example, the limited memory space for these scopes does not necessarily affect information retention of throwables generated upon scope exit.

Hereinafter, a more detailed discussion of methodologies facilitating the advantages illustrated above are described with reference to FIG. 5.

Turning to FIG. 5, a method of optimizing the handling of throwables in a real-time compliant java virtual machine is illustrated. The method 500 includes receiving a throwable at block 501 as a scope is being exited.

For example, in a scoped memory space of a real-time compliant java virtual machine, a throwable may be generated or thrown at any particular scope. Any generated throwable may be received, or caught, and optimization operations may be facilitated before scope exit. Upon receipt of the throwable, the Java stack is traversed at block 502. The Java stack provides information related to program instructions relating to “trying” and/or “catching” exceptions. As the stack may include additional “try-catch” blocks introduced by the virtual machine implementation, it may be beneficial to ignore intermediate “try-catch” blocks or other code portions during traversal.

Turning back to FIG. 5, the method 500 further includes identifying a throwable catch area at block 503 during traversal. For example, a throwable catch area is the application code where the received throwable will be, or should be, caught/handled during program execution. Upon identification of the throwable catch area, the method 500 includes identifying the scope memory area that is active in the throwable catch area at block 504. For example, the throwable active area is the scoped memory space which will be, or should be, active upon the catching/handling of the throwable. Upon identification of the throwable active area, information from the received throwable is propagated to a new ThrowBoundaryError created within the identified memory area.

For example, at least one example embodiment includes walking the Java stack for traversal of block 502. Through examination of specific class and object instances referenced by code portions found in the stack during traversal or available in the stack itself, the throwable active area may be determined as the last memory area entered before the throwable catch/handling area.

Alternatively, additional Java stack information may be appended in a virtual machine implementation to aid in identification of the throwable active area and the throwable catch/handling area. For example, extensions to conventional java stack information may be implemented within a virtual machine to facilitate the methodologies described above. Through inspection of the extensions, identification of the throwable active area and the throwable catch/handling area may be provided. The extensions may include specific scoped memory area instance information for corresponding stack areas. This information may be used in determining the throwable active area.

Therefore, as described above, example methodologies are provided which optimize throwable handling in real-time compliant java virtual machines. The virtual machines may include scoped memory space, and may facilitate a method including receiving a throwable, traversing a Java stack, identifying a throwable catch/handling area, identifying a throwable active area, and propagation of information from the throwable to a ThrowBoundaryError created in the throwable active area. The propagation reduces repetitious cloning of the throwable information during scope exits, and retains information that might otherwise be lost in conventional implementations of virtual machines.

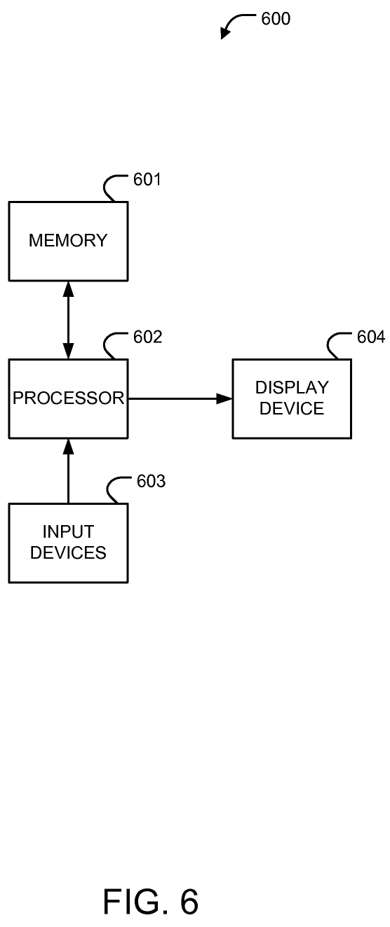

Furthermore, according to an exemplary embodiment, the methodologies described hereinbefore may be implemented by a computer system or apparatus. For example, FIG. 6 illustrates a computer apparatus, according to an exemplary embodiment. Therefore, portions or the entirety of the methodologies described herein may be executed as instructions in a processor 602 of the computer system 600. The computer system 600 includes memory 601 for storage of instructions and information, input device(s) 603 for computer communication, and display device 804. Thus, the present invention may be implemented, in software, for example, as any suitable computer program on a computer system somewhat similar to computer system 600. For example, a program in accordance with the present invention may be a computer program product causing a computer to execute the example methods described herein, including implementation of the aforementioned java virtual machine and optimization methods.

The computer program product may include a computer-readable medium having computer program logic or code portions embodied thereon for enabling a processor (e.g., 602) of a computer apparatus (e.g., 600) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

As described hereinbefore, example embodiments of the present invention provide novel methods, systems, and computer program products for optimizing the handling of throwables in a real-time compliant java virtual machine. According to at least one example embodiment, a method of optimizing the handling of throwables in a real-time compliant java virtual machine includes receiving a throwable generated within a first memory scope area on exit from that scope in a real-time java compliant virtual machine, traversing the Java stack, identifying the application code where the received throwable will be, or should be, caught/handled during program execution, identifying a second memory scope area within the stack of memory scopes, the second memory scope area being the area which will be active during catching and handling of the received throwable, and propagating information from the received throwable to the second memory scope area irrespective of the scope areas between the first and second scope area.

According to the example embodiment, traversing the Java stack includes ignoring some try-catch code portions referenced by the stack.

According to the example embodiment, identifying the second memory scope area includes interpreting class and object instances corresponding to code portions in the Java stack where the received throwable is caught and/or handled.

According to the example embodiment, identifying the second memory scope area includes interpreting extended information appended to the Java stack to identify a memory space which will be active during the catch or handling of the received throwable.

As further described hereinbefore, example embodiments of the present invention provide additional novel methods, systems, and computer program products for optimizing the handling of throwables in a real-time compliant java virtual machine. Additional embodiments are described below.

An embodiment of the invention includes a method of optimizing the handling of throwables in a real-time compliant java virtual machine. The method includes receiving a throwable generated within a memory scope of a scoped memory space of the real-time java compliant virtual machine, traversing a stack of memory scopes of the scoped memory space, identifying a first memory scope area within the stack of memory scopes, the first memory scope area being an area catching and handling the received throwable, identifying a second memory scope area within the stack of memory scopes upon identification of the first memory scope area, the second memory scope area being an area which will be active during catching and handling of the received throwable in the first memory scope area, and transferring the received throwable to the second memory scope area.

Another embodiment of the invention includes a computer program product. The computer program product includes a computer program with computer executable instructions that, when executed on a computer apparatus, direct a processor of the computer apparatus to execute the computer executable instructions, the computer executable instructions including a method of optimizing the handling of throwables in a real-time compliant java virtual machine. The method includes receiving a throwable generated within a memory scope of a scoped memory space of the real-time java compliant virtual machine, traversing a stack of memory scopes of the scoped memory space, identifying a first memory scope area within the stack of memory scopes, the first memory scope area being an area catching and handling the received throwable, identifying a second memory scope area within the stack of memory scopes upon identification of the first memory scope area, the second memory scope area being an area which will be active during catching and handling of the received throwable in the first memory scope area, and transferring the received throwable to the second memory scope area.

Another embodiment of the invention includes a system. The system includes a computer processor, a real-time compliant java virtual machine implemented on the computer processor, memory in communication with the computer processor, and a scoped memory space implemented within the memory. The system is configured to perform a method including receiving a throwable generated within a memory scope of a scoped memory space of the real-time java compliant virtual machine, traversing a stack of memory scopes of the scoped memory space, identifying a first memory scope area within the stack of memory scopes, the first memory scope area being an area catching and handling the received throwable, identifying a second memory scope area within the stack of memory scopes upon identification of the first memory scope area, the second memory scope area being an area which will be active during catching and handling of the received throwable in the first memory scope area, and transferring the received throwable to the second memory scope area.

With only some example embodiments of the present invention having thus been described, it will be obvious that the same may be varied in many ways. The description of the invention hereinbefore uses these examples, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims.

What is claimed is:

1. A method of optimizing the handling of throwables in a real-time compliant java virtual machine, comprising:
receiving a throwable generated within a first memory scope area on exit from that scope in a real-time java compliant virtual machine;
traversing a Java stack to identify application code where the received throwable will be, or should be, caught/handled during program execution;
identifying a second memory scope area within the Java stack, the second memory scope area being the area which will be active during catching and handling of the received throwable; and
propagating information from the received throwable to the second memory scope area irrespective of the scope areas between the first and second scope area.

2. The method of claim 1, wherein traversing the Java Stack includes all try-catch code portions contained within the code referenced by the Java Stack.

3. The method of claim 1, wherein traversing the Java Stack includes ignoring some try-catch code portions contained within the code referenced by the Java Stack.

4. The method of claim 1, wherein identifying the first memory scope area occurs by identifying the memory area as the area in which the throwable was allocated

5. The method of claim 1, wherein identifying the second memory scope area includes interpreting class and object instances corresponding to code portions referenced by the Java stack to identify a memory space which will be active during the catch or handling of the received throwable.

6. The method of claim 1, wherein identifying the second memory scope area includes interpreting extended information appended to the Java stack to identify a memory space which will be active during the catch or handling of the received throwable.

7. A computer program product including a computer usable medium having computer executable instructions embodied therewith that, when executed on a computer apparatus, carry out a method of optimizing the handling of throwables in a real-time java compliant virtual machine, the method comprising:
receiving a throwable generated within a first memory scope area on exit from that scope in a real-time java compliant virtual machine;
traversing a Java stack to identify application code where the received throwable will be, or should be, caught/handled during program execution;
identifying a second memory scope area within the Java stack, the second memory scope area being the area which will be active during catching and handling of the received throwable; and
propagating information from the received throwable to the second memory scope area irrespective of the scope areas between the first and second scope area.

8. The computer program product of claim 7, wherein traversing Java Stack includes all try-catch code portions contained within the code referenced by the Java Stack.

9. The computer program product of claim 7, wherein traversing the Java Stack includes ignoring try-catch code portions contained within the code referenced by the Java Stack.

10. The computer program product of claim 7, wherein identifying the first memory scope area occurs by identifying the memory area as the area in which the throwable was allocated.

11. The computer program product of claim 7, wherein identifying the second memory scope area includes interpreting object instances corresponding to code portions referenced by the Java stack to identify a memory space which will be active during the catch or handling of the received throwable.

12. The computer program product of claim 7, wherein identifying the second memory scope area includes interpreting extended information appended to the Java Stack to identify a memory space which will be active during the catch or handling of the received throwable.

13. A system comprising:
a computer processor;
a real-time compliant java virtual machine implemented on the computer processor;
memory in communication with the computer processor; and
a scoped memory space implemented within the memory; wherein the system is configured to perform a method comprising,
receiving a throwable generated within a first memory scope area on exit from that scope in a real-time java compliant virtual machine;
traversing a Java stack to identify application code where the received throwable will be, or should be, caught/handled during program execution;
identifying a second memory scope area within the Java stack, the second memory scope area being the area which will be active during catching and handling of the received throwable; and
propagating information from the received throwable to the second memory scope area irrespective of the scope areas between the first and second scope area.

14. The system of claim 13, wherein traversing Java Stack includes all try-catch code portions contained within the code referenced by the Java Stack.

15. The system of claim 13, wherein traversing the Java Stack includes ignoring try-catch code portions contained within the code referenced by the Java Stack.

16. The system of claim 13, wherein identifying the first memory scope area occurs by identifying the memory area as the area in which the throwable was allocated.

17. The system of claim 13, wherein identifying the second memory scope area includes interpreting object instances corresponding to code portions referenced by the Java stack to identify a memory space which will be active during the catch or handling of the received throwable.

18. The system of claim 13, wherein identifying the second memory scope area includes interpreting extended information appended to the Java Stack to identify a memory space which will be active during the catch or handling of the received throwable.
